(19) United States
(12) Patent Application Publication
(10) Pub. No.: US 2002/0065935 A1
(43) Pub. Date: May 30, 2002

(54) Method and system for a modular residential gateway

(76) Inventors: Frank R. Koperda, Suwanee, GA (US); David Lin, San Jose, CA (US)

Correspondence Address: GREGORY SCOTT SMITH, P O BOX 2192, FREMONT, CA, 94536

(21) Appl. No.: 09/794,809

(22) Filed: Feb. 26, 2001

Related U.S. Application Data
(60) Provisional application No. 60/241,780, filed on Oct. 18, 2000.

(51) Int. Cl. G06F 15/173; G06F 15/16

(52) U.S. Cl. 709/238; 709/230

(57) ABSTRACT

The invention is a scalable modular network system, without a fixed size enclosure, that may include many kinds of voice and data components. In operation, the invention provides trans-coding transparency allowing effective communications between dissimilar data/voice data streams. The modular system includes unique power control and distribution methods. The invention also provides the methods to simplify network-provisioning tasks because of the method of intelligently determining network information. The placement of the invention is not required to be in a central wiring location because the gateway system automatic adapts to having its components in distributed physical locations.

### CROSSREFERENCE TO RELATED APPLICATIONS

Benefit of the priority of the Oct. 18, 2000 filing date of provisional application 60/241,780 is hereby claimed.

### FIELD OF THE INVENTION

The present invention relates generally to systems for facilitating communications between a variety of kinds data/voice communications networks. More specifically, the invention relates to a scalable modular network system that may include many kinds of voice and data components.

### BACKGROUND OF THE INVENTION

The connection between computers has evolved from simple connections to complex networks needing sophisticated routing protocols, protocol converters to connect heterogeneous networks and computers to help with network services such as address management, network management, and traffic monitoring. The cost of owning these networks is high, requires skilled employees, and is difficult to change.

Communications networks that were once restricted to businesses are now moving into the residential environment. The deployment of residential high-speed communications has begun using Cable modems, ADSL, and wireless MAN technologies. These communications technologies carry not only computer data, but also voice and video services. It is very likely that residences will need to distribute this data to more than just a single device and therefore will need a residential communications network.

While consumers desire to obtain the benefits provided by communication networks, the technology used by today's businesses may not be readily applied to the residence. Attempts have been made to create a simple residential gateway modular system, but prior attempts have not been universally accepted in the market. Obstacles to the acceptance of residential gateways include: (a) generally high initial cost of the enclosure, power, and control modules, (b) cost and effort required to wire the gateway to all the places in the home that the information is needed, (c) difficulty in supplying back-up power for life-line services when the main power fails, (d) the generally high level of technical skill required to configure and diagnose problems, and (e) the high cost of adding new modules as new networking technologies evolve

What is needed is a modular gateway system network system that avoids the limitations and problems inherent in prior art attempts.

### SUMMARY OF THE INVENTION

In general the invention is a modular electronic communications system capable of communicating between a variety of heterogeneous communications networks using any of a variety of communications protocols. The system is designed to be flexible, and easily set up and managed by individuals who do not necessarily have skills related to managing electronic communication networks, and may be used in both residential and business environments.

The modular electronic communications system generally includes at least two modules that together form a stack. The modular design of the electronic communications system allows a variable geometric configuration having a shape determined by the number of modules, or in other words, without a fixed size enclosure. The electronic communications system is capable of accepting additional modules as desired by the user, and the modules are capable of transferring electronic messages to and from other modules in the electronic communications system. In a preferred embodiment of the electronic communications system, the modules within a stack may be placed in any order.

The electronic communications system may include more than one stack of modules, and the additional stacks maybe positioned in a physically separate selected location from the first stack. The electronic communications system may further include a means or mechanism for allowing power to be distributed to the modules in a stack including the following elements: at least one power supply, a processing element, a means for conveying the power requirements of each the module to the processing element, and a means for allowing the processing element to instruct each the module to obtain power from a specified power supply. In some embodiments, a stand-by power supply may be available. The stand by power supply is preferably always on and resistant to interruption, and available only to modules identified by the processing element as requiring access to stand-by power in the event other power supplies are unavailable.

The electronic communications system also include at least one internal communication bus, a means for selecting at least one communications bus to send electronic messages, and a means for selecting at least one communications bus to receive electronic messages.

The electronic communications system of claim also may include a means for allowing communications between heterogeneous protocols, wherein the means for allowing communications between heterogeneous protocols includes the following elements: a means for selectively admitting a message entering a first module from a first network using a first communication protocol, a means for allowing translation of the message by the first module to a second communications protocol, a means for selectively admitting the message into the second module, and a means for allowing translation by the second module of the second protocol to a third protocol used by a second network.

The electronic communications system of claim may further include a mechanism for allowing proper configuration of the electronic communication system, which includes the following elements: a processing element, a means for storing information in each the module about the module, a means for the processing element to retrieve the information from each the module, and a means for the processing element to configure the electronic communication system using the information obtained from the modules.

The electronic communications system may further include a means for monitoring the operation of the modules including the following elements: a processing element, a means for allowing the processing element to communicate with the modules to retrieve information associated with the functioning of the modules, and a means for allowing the processing element to determine whether the modules are functioning within accepted parameters. In alternate embodiments, the electronic communications system may further include a means for allowing the processing element to communicate with other communications devices located externally.

The invention also includes several methods of using one or more embodiments of the invention described above. One method of the invention includes the following method steps: (a) using the processing element to identifying at least one communication bus that will be used by the first module to communicate a message to at least one second module, (b) using the processing element to instruct the first module to select at least one identified bus, (c) using the processing element to instruct each second module to select an identified bus, (d) using the first module to transmit a message on at least one of the identified buses, (e) using each second module to receive the message on the identified bus.

Another method of the invention generally includes the following method steps to perform system configuration: (a) identifying the modules that are present in the electronic communications system, (b) determining which modules may need to communicate with each other, (c) determining the types of addresses needed for each module, (d) establishing internal communications paths between the modules, and (e) establishing connections between modules when communications between the modules is required.

An alternative method generally includes the following method steps: (a) identifying which modules present in the electronic communications system, (b) determining which modules may need to communicate with each other, (c) determining the types of addresses needed for each module, (d) establishing internal communications paths between the modules, (e) constructing a customized information request, (f) transmitting the customized information request to an external entity, (g) receiving an answer to the customized information request, (h) implementing a system configuration.

Another method of the invention to perform network management functions includes the following method steps: (a) determining a normal operational parameters of the modules, (b) monitoring actual operational parameters of the modules, (c) comparing the actual operation parameters with the normal operational parameters, and (d) logging of events when the actual operational parameters are outside of the normal operational parameters. In alternate embodiments, this method may further include the following method steps: (e) allowing the processing element to communicate with at least one externally located device, (f) informing the externally located devices of events logged in method step (d).

### LIST OF DRAWINGS

FIG. 1 shows one example configuration of an embodiment of the modular system comprising one stack of four modules.

FIG. 2 shows one example configuration of an embodiment of the modular system comprising one stack of four modules and a second stack of two modules.

FIG. 3 shows a block diagram of one embodiment of the inter-module connections of the gateway system of the invention.

FIG. 4 shows a block diagram of one embodiment of the power supply interconnection of the gateway system of the invention.

FIG. 5 shows a block diagram of one embodiment of a typical digital cable module of the gateway system of the invention.

### DETAILED DESCRIPTION

The invention is a system that provides connection between a variety of networks and may transport voice, video, and data. The system preferably is configured to be flexible, and easily set up and managed by individuals who do not necessarily have skills related to managing electronic communication networks. A modular design has been adopted as it may have a very low initial costs, scales well as additional numbers and types of networks are added, and may be installed easily by users who are not network experts.

In general, it is expected that the residential networks will be viewed as being a collection of network access technologies, home network technologies, and network services. There are many solutions to each of these today and it is expected that this will grow over the next few years with new solutions to customer needs.

Table 1 provides an example list of the network technologies categories that could be provided by modules in the gateway system of the invention. This is not meant to be an exhaustive list.

TABLE 1

| Network | Home | | Misc. |
|---|---|---|---|
| interfaces | interfaces | Wireless modules | modules |
| DOCSIS | Ethernet | IEEE 802.11a | power |
| ADSL | HomePNA | IEEE 802.11b | Security |
| ADSLite | Bluetooth | HomeRF | Firewall/ |
| | | | Router |
| T1 | Homepower | HiperLAN II | VPN |
| T3 | 2-Line POTs | 900 MHz cordless | Standby |
| | | phone | power |
| SDSL | 4-Line POTs | 2.4 GHz cordless | NAT/DHCP |
| | | phone | |
| ISDN | Security Panel | | Softswitch |
| | Monitoring | | PBX |
| | | | functions |
| V.90 (56K) | Utility Monitoring | | |
| modem | | | |
| HDTV Tuner | Multi-port Ethernet | | |
| | Hub | | |
| VDSL | Cordless Telephony | | |
| FDDI | Camcorder Video | | |
| | (HAVI - IEEE 1394) | | |

As may be readily observed, there are a significant number of combinations of communications paths that may be established between the 35 modules. Among the major challenges facing the connectivity between heterogeneous networks are: (a) there are many different types of addresses used, (b) some addresses may be statically assigned and some dynamically assigned, (c) signaling the desired Quality of Service (QoS) for a connection is not done uniformly between the various protocols, (d) there are various packet formats used, (e) some services and devices must remain operational in the event of loss of power (i.e. life-line services). Previous attempted gateway systems have suffered from an number of disadvantages or limitations, including:

(a) Some prior art systems were created as a fixed function box containing a limited sub-set of Table 1 interfaces (e.g. a DOCSIS cable modem, router, Ethernet hub, with an analog POTs port). Such fixed-function boxes generally may not be readily extended to new technologies.

(b) Some prior art systems used a single large enclosure that had slots for a fixed limited number of pluggable modules. Generally, these systems had a power supply that was sized for the maximum power of some pre-determined combination of modules, and frequently featured a high initial cost, especially if only one module was needed.

(c) Other prior art systems had to be located at a specific point in the home to receive the external network interface connection (e.g. Cable TV connection), power, standby power, and connect into existing home wiring (e.g. telephone line). These systems typically are not readily installed by an untrained consumer and are not easily accessible for upgrading. Furthermore, new networking technologies might not have wiring nearby the system enclosure.

In the preferred embodiment of the modular gateway system of the invention described herein, the disadvantages of the prior art are avoided. For example, modular gateway system is not fixed function and may grow in capability as the customer requires and as new communications technologies are created. Also, there is no single large enclosure with many unused slots. If only one module is needed, the system is one module. The power supply is provided for a limited number of modules and additional power supply modules are added as required by the customer.

Furthermore, the location of the modular system is flexible since many different technologies may be freely intermixed. For example, in a conventional system, if a computer was connected to a cable modem and the phone service was over the cable TV system, the chassis must be physically at the point where all three systems interconnect or expensive home re-wiring is required (not convenient for rental situations or older homes). However, in the present invention, a wireless module and a cable modem module may be combined in one location; a wireless module with an Ethernet module (computer connection) and the POTs module may be combined at another location in the residence.

The cross-connection of various networks is a difficult problem because of the number of potential connections and also because of the wide variety of data encoding schemes used. For example, possible devices/networks offering voice service include: (a) a connection from the Public Switch Telephone Network (PSTN), (b) a PACKETCABLE™ call over the DOCSIS (Cable Modem) using Voice over IP (VoIP) technology, (c) a Voice over ATM (VoATM) call using ADSL technology, (d) an analog phone (Plain Old Telephone-POTs), (e) an IP phone connected to an Ethernet network, (f) a cordless digital phone using the 900 MHz spectrum employing Pulse Code Modulation (PCM), (g) a cordless digital phone using the 2.4 GHz spectrum employing VoIP technology, or (h) a DSO channel on a T1 line.

In the present invention, all combinations of the voice technologies may occur. It is not restricted to just any two types but it may have three, four or more types. There may also be more than one call going on concurrently.

Similarly, wiring is not restricted to a single place nor even to a usual place. For example, the home phone wiring normally may go to a Network interface Device (NID) located at the side of the home. If the telephony service was from PACKETCABLE™ over the cable TV coax cable instead of the PSTN into the NID, the POTs module from this invention may plug into any home phone outlet and could feed all the phones in the home using the home wiring.

In the example just described, the wiring was mentioned and the present invention may also need to do the protocol conversion. The VoIP connection may be decoded by the DOCSIS module and the call control signaling may be routed to the system processor. The system process had been told during configuration that a there was an association between a particular VoIP identifier and the POTs line and it may activate the ringing voltage of the POTs module.

The DOCSIS module may decode the VoIP data stream and transcode it to a PCM data stream which may be sent to the POTs module for entry into the Digital to Analog converter (DAC) which may then go to the standard telephone handset in the home.

Another example may be VoATM from ADSL going to a cordless VoIP phone. The signaling may go from the ADSL modem to the system processor which may then signal to the cordless phone module to initiate a ring at the cordless phone. The ADSL modem may decode the VoATM cell into a PCM data stream and send it the cordless phone module which may encode it into the VoIP format and send it wirelessly to the phone.

If the Standby power module was attached and a power failure occurred in the above example, the system processor may deactivate all unnecessary modules and the ADSL and cordless phone may receive the requisite power to ensure proper operation. The data interfaces on the ADSL module may be deactivated to save power.

The following list includes a number of features and characteristics that are considered to be patentably distinct form the prior art in the preferred embodiments of the modular gateway of the invention: (a) the ability to create a low cost network initially by selecting only the technologies that are immediately needed, without requiring a fixed size enclosure, (b) the ability to extend the communications to other network technologies as the need arises at a low incremental cost, (c) provide multiple communications services to the various connected networks by providing connections between the networks, using appropriate signaling protocols on each network, providing address services such as setting addresses, resolving addresses, and translating addresses, and by translating, as required, the protocols between the services, (d) managing the configuration of the system in a simple way using simple rules based solely on the modules installed, (e) monitoring the health of the networks since the integrated approach allows viewing of the overall system, and (e) diagnosing and isolating network problems since individual networks may be isolated.

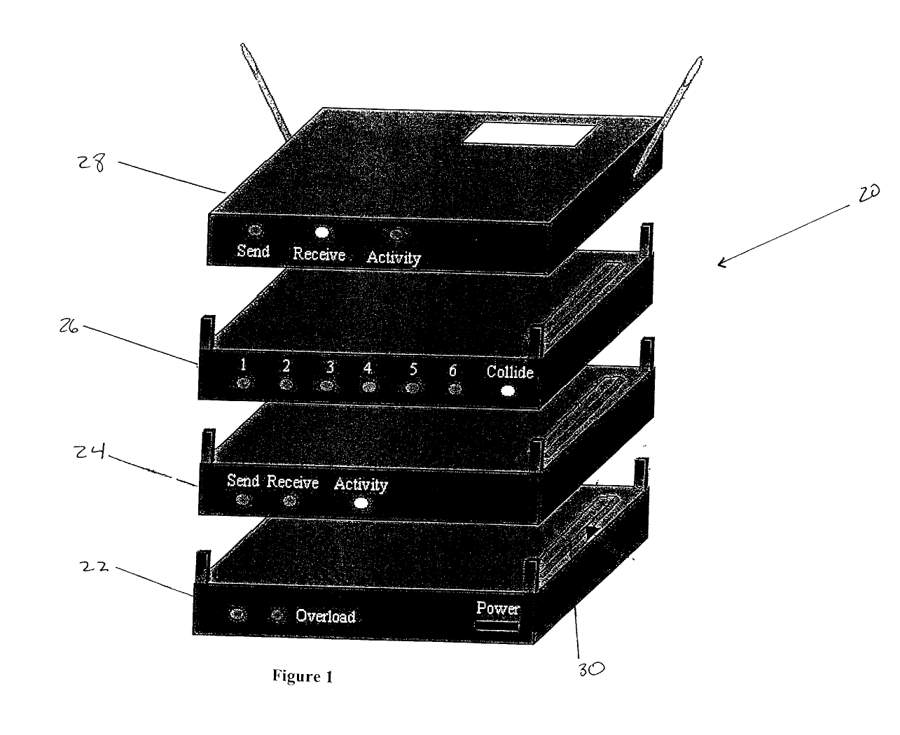

FIG. 1 shows a first preferred embodiment of the present invention, however, the invention is not restricted to the physical shape shown. Furthermore, in addition to the vertical stacking shown, horizontal stacking, and other forms of module interconnection are possible without affecting the basic operation of the invention.

Several exemplary modules are shown in FIG. 1, however, modules using any network technology may be used, and the configuration shown in FIG. 1 is provided only as an example, and other combinations of modules are comprehended by the invention.

In the preferred embodiment shown, the power supply 22 provides the power for the “stack” of modules 20. The DOCSIS modem 24 provides the connection to an external network that will allow data to be transported through the metropolitan area and into the Internet. The Ethernet module 26 allows distribution of data to local devices in the residence. The wireless module 28 takes the appropriate data packets and sends them through the air to remote computers located in the residence.

Alternate combinations of functions are also possible. For example, the power supply module 22 may be combined with the wireless module 28, the Ethernet module 26 may be combined with the DOCSIS modem 24, or the Ethernet module 26 may be combined with the power supply 22. Many of the functions shown in Table 1 may be combined into a single module as alternate embodiments to the preferred embodiment without alternation of the invention.

In the preferred embodiment shown, stacking pegs 32 assist he proper alignment of the modules when stacked together. The modules communicate with each other using connectors that are mated when stacked together. It is also possible to connect the modules together with cables, fiber, and other interconnect technologies in alternate embodiments of the invention. As shown, a cover 30 over the connector provides protection from dust and dirt. The cover 30 preferably retracts as the modules are brought together allowing the connectors of the modules to become available for mating. Alternate embodiments of the invention allow for no cover, non-contacting interconnection allowing no cover movement, or different positions and techniques for retraction.

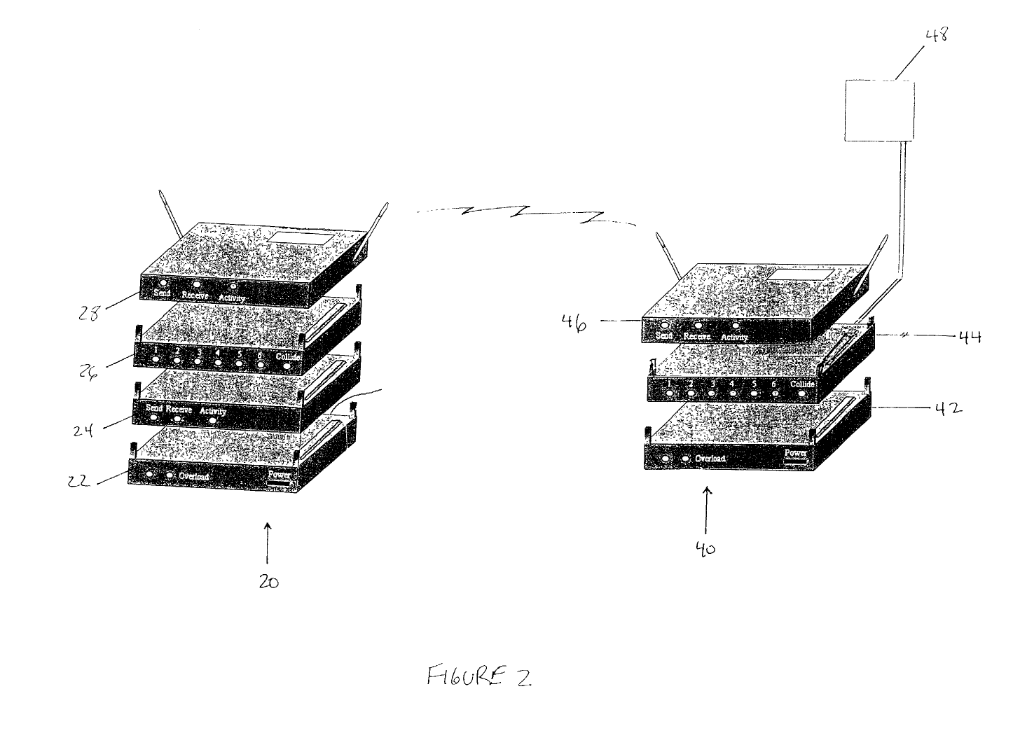

FIG. 2 shows one example configuration of an embodiment of the modular system comprising the stack 20 of four modules as seen in FIG. 1, and a second stack 40 of three modules including a power supply module 42, and Ethernet module 44 and a wireless module 46. In the configuration shown in FIG. 2, the wireless module allows communication with the first stack 20, while the Ethernet module allows communication to external devices such as the computer 48. In alternate embodiments additional stacks may exist. Furthermore, any stacks after the first stack may consist of few as one module, and of as many modules as are required in the particular location.

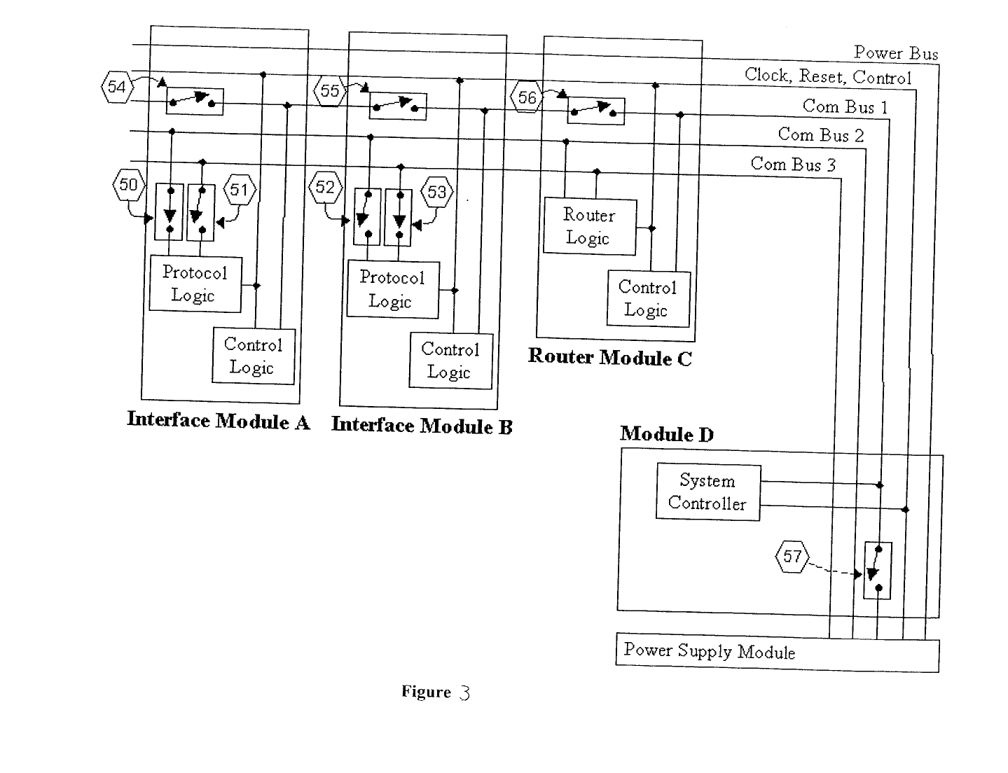

FIG. 3 shows an example configuration of the interconnection between several modules of a an embodiment of the home residential gateway of the invention. Other configurations may be useable or preferred. The modules shown in FIG. 3 are an interface module A and B that are able to communicate with other external devices using one of the many communications protocols available. Modules A and B may be any kind of communication modules desired. Also shown is a Router device C, a systems controller device D, and a power Supply module. In the preferred embodiment, The router device C and the systems controller device D may be integrated with one or more interface modules, but are shown here separately for clarity. In alternate embodiments, the router device C and the systems controller device may be separate modules, or still other embodiments may be incorporated in one or more communications modules. Various combinations of the module functions are possible and considered as alternate embodiments.

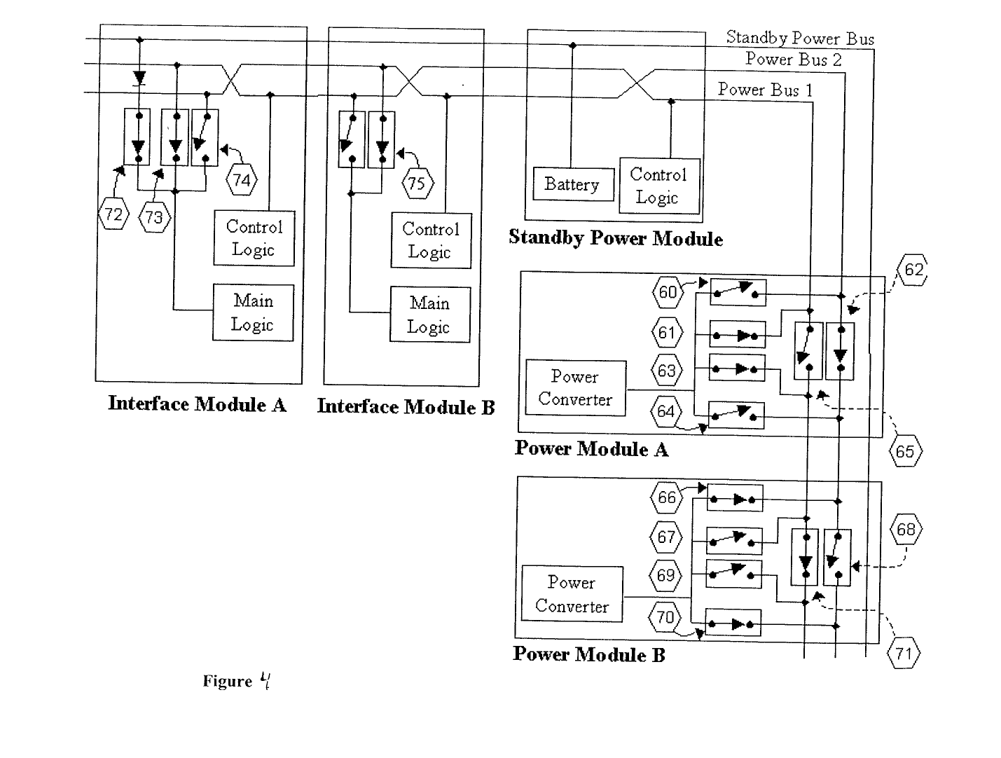

Connecting the modules are several buses such as a power bus, clock bus, and communications buses 1, 2, and 3. The nature of the communications buses in a preferred embodiment is to use a serial communications protocol with parallel data buses to be considered as an acceptable alternate embodiment. The power supply bus will be discussed in more detail with reference to FIG. 4. A clock bus provides clocking to the various modules to reduce the necessity of duplicating the function. In alternate embodiments, it may be preferred that no common clock is used, or that clocking is provided to only some of the modules. There are three communications buses shown in the preferred embodiment: 1, 2 and 3 with alternate embodiments having a single bus, dual buses, or more than three buses.

Communications Bus 1 is preferably used by the System Controller to communicate supervisor messages with all the modules and is capable of transferring data directly between modules. Communications buses 2 and 3 are higher performance paths used to transfer user data between modules.

In the preferred embodiment, communications bus 2 is used to carry data to the external network access which goes to a public network, while communications bus 3 carries the residential data. Keeping residential and external data communications on separate communications buses enhances security. In alternate embodiments, a single Communications Bus is possible and security may be provided through other known methods if desired. With additional buses, security and bandwidth may be increased and should be considered as an alternate embodiment.

The basic operation of the initial communications with the modules by the system controller device D is to establish the identity and characteristics of the modules in the system. In the preferred embodiment, the system controller D sequentially surveys each attached module. In one preferred embodiment, the survey is accomplished according to the following method:

(a) power is supplied to the modules,

(b) modules A, B, C, and D turn off their respective communications bus 1 pass-thru switches 54, 55, 56, and 57.

(c) The system controller device sends a message asking for module information and only module C is able to receive the message since the communications path in all other directions has been disconnected. Module C responds with information such as its type, capabilities, and power requirements. The System Controller then tells module C to turn on its pass-thru switch 56 and to not respond to further module identification messages.

(d) The system controller D sends a message asking for module information and only module B is able to receive the message since the communications path in all other directions has been disconnected. Module B responds with information such as its type, capabilities, and power requirements. The System Controller then tells module B to turn on its pass-thru switch 55 and to not respond to further module identification messages.

(e) The System Controller sends out another message asking for module information and only module A is able to respond and it too provides the proper information. In this manner, all modules may be identified in both capabilities and also the actual order of how the modules are connected.

Based on the desired functions established by the customer through a configuration process, the next sequence of steps are performed. For this example, assume the customer has installed a DOCSIS cable modem as module A, a wireless Local Area Network (LAN) as module B, and a router module as module C, along with previously mentioned System Controller and power Supply modules.

The DOCSIS module is activated, configured and receives the proper addresses to enable the transfer of the user data. Switch 50 is enabled which places the DOCSIS data onto communications bus 2. Router module C receives the data and, if destined for the Wireless LAN module, forwards the information onto communications bus 3. Wireless LAN module has activated its pass-thru switch 53 enabling communications bus 3 data to be received and sent to its destination.

In an alternate scenario, should the Router module not be present, the wireless LAN module may have activated its pass-thru switch 52 enabling communications bus 2. This may have allowed module A to directly communicate with module B. In more complicated scenarios, other modules may be present and could send and receive data on any of the Communications Buses allowing complex data exchanges to occur.

Any desired types of communications protocols may be used, and communications buses 2 and 3 may transmit protocols ranging from a simple Ethernet protocols, to USB protocols, or a complex protocol such as ATM that has Quality of Service (QoS) checking. The buses may be shared media, point-to-point, redundant, serial, parallel, or optical and all of these concepts are to be considered as alternate embodiments of this invention.

FIG. 4 shows the interconnection of the voltage from the power supply(s). The basic requirement for the flexible design of the Modular residential gateway is that any module may be placed in any sequence. There must be at least one power Supply module and the simultaneous use of more than one power supply is supported. The source of electricity from the power supply may be an outlet or battery, or any other known and useable source of electricity.

In the preferred embodiment, power module A, power module B, and a Standby power module may be present. Power modules A and B may receive their primary power through the residential power system and the Stand-by power module may have a rechargeable battery inside the module or placed nearby. Alternate embodiments may allow a power module and a Standby power module to be combined into a single module or be combined with any other module.

Other alternate embodiments of the invention may allow for a single power supply, no stand-by power or a limited number of power Supply modules to be present. These alternate embodiments may allow for a reduction in complexity of the design being described.

The System, upon power-up, may perform the following sequence of events to properly perform the functions described.

(a) Power module A and B, when turned on, may feed power to power bus 1 and power bus 2. It is unlikely that both power supplies may be of the exact same voltage and therefore the power supply with the greater voltage may initially supply the needed power.

(b) All the other modules may power-up with only a small amount of logic being powered thus allowing a minimal drain from the power. This control logic may be the minimal logic for the System Processor to be able to communicate with the individual module to determine the modules type and power requirements.

(c) When the System Processor has calculated that sufficient power is available from the power supply modules for the proper operation of all the modules, the System Processor will sequence the power: (a) the System Processor may instruct power module A to feed power bus 1 by activating pass-thru switch 61 and 63, (b) the System Processor may instruct power module B to feed power bus 2 by activating pass-thru switch 66 and 70, (c) the System Processor will instruct interface module A to receive power from power bus 1 by activating pass-thru switch 73, (d) the System Processor may instruct interface module B to receive power from power bus 2 by activating pass-thru switch 75.

In the embodiment shown in FIG. 4, power bus 1 and power bus 2 alternate their position when going through each module in the preferred embodiment. The reason this is done is to evenly share the load of the control logic when two or more power modules are supplying power to the system. The alternating avoids the complexity of enabling the control logic to select from either power bus. However, in alternate embodiments, other configurations may be used that do not include reversal of the power buses.

It is possible to have more than two power supplies operate within the modular system. The third power module may be placed somewhere in the stack of modules at a position indicated by the configuration manager. The configuration manager may have access to the module power requirements and could instruct the user about the proper position. The power modules preferably have the capability to turn off the power pass-thru switches on both power bus 1 and power bus 2. The third power module may be inserted into the stack and power module A could be instructed to deactivate its pass-thru switch on power bus 1 (65 and 63). The third power module may be instructed to feed its power to power bus 1 which may feed the modules formerly serviced by power module A. In a similar manner, a fourth power module could be employed should there be a need.

Maintaining service during a power outage is a desirable feature especially if life-line telephony service is being provided (e.g. PACKETCABLE™). The customer need not incur the cost of this feature unless the function is required. Three types of stand-by scenarios include: (a) the network operator fully powers the Customer Premise Equipment (CPE), (b) the network operator partially powers the CPE, (c) the network operator provides no power for the CPE.

In Scenario (a), the network interface device such as a DOCSIS cable modem receives the power over the coax line and into the Modular Residential Gateway. If the network has sufficient power, it feeds stand-by power into the Stand-by power bus of the Modular residential gateway, which may transport the power to the modules that will remain active during a power outage.

In Scenario (b), the operator may supply network powering for cable telephony but the operator may not provide sufficient power to keep the wireless module active when the customer uses a cordless phone. In this case, the DOCSIS module is powered by the network interface (e.g. the coax) and the rest of Modular residential gateway may be powered by the Stand-by power module.

In Scenario (c), the cable telephony service provider does not provide network powering of the cable modem and a standby power source is required for that and for an analog POTs phone module that is part of the Modular Residential Gateway. In this case the entire modular residential gateway may be powered by the Stand-by power module.

If the standby power module is installed, the configuration manager may assist in determining which modules the customer may be using to obtain the telephony service. This configuration information may be available to the Systems controller to allow for the activation of the power pass-thru switch 72 which enables interface module A to obtain power from the Standby power Bus.

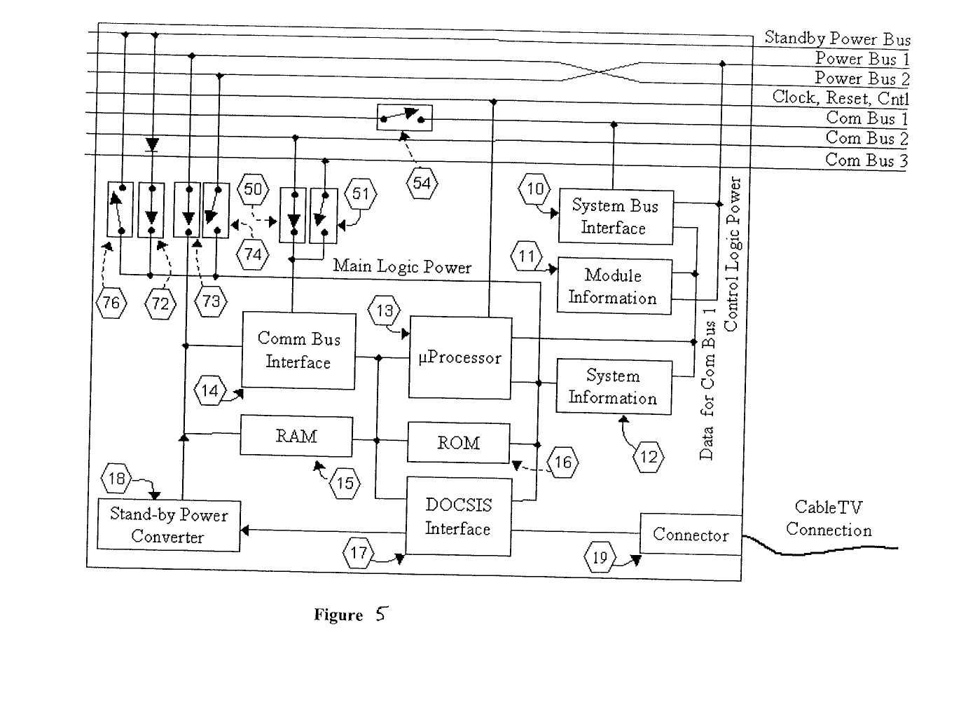

FIG. 5 provides the internal functional blocks of a preferred typical module configuration that is part of the gateway. There are many variants allowed in alternate embodiments. This description should not be inferred as the only way in which the modular functions may be implemented.

The control logic consists of the interface to one of the communications buses 10 (i.e. Com Bus 1) and the module information storage device 11, which contains information about the module which is available to the system processor which is not within this module. The type of information that may be contained within the module information storage device 11 includes: (a) module function (i.e. Voice, Video, Network interface, Home Network interface, Services, or combinations), (b) the module serial number, default addresses, manufacture date, version number, and (c) amount of power needed (electrical current) for the main logic power, amount of power needed for control logic power, type of power needed (e.g. standby power). Other information useful to the management or control of the modular system may also be stored, if desired.

After the system processor has determined that sufficient power is available, the module is able to power-up using the appropriate power bus (1 or 2) through switch 73 or 74. The local microprocessor (13) preferably is capable of performing a diagnostics routine on the module and may also provide more information useful to the System 12. The type of information that may be provided by the local microprcessor 13 may include: (a) configuration information that may be used by the system configuration manager, (b) code for the system Configuration manager that may allow a new type of module to interact with older modules to perform new services (this code may allow existing parameters to interact with parameters required for this module), and (c) code for a service processor that may allow a new type of module to interact with older modules to perform additional services.

For example, if this were a DOCSIS module, the module could implement a particular selected voice architecture, such as PACKETCABLE™ voice architecture, and this code could be used to translate POTs signals from a module into voice over IP (VoIP) packets being used in this module.

The system processor may instruct this module to use either (or both) of the other communications buses through switches 50 and 51 to connect into the communication bus interface 14 section. The module shown provides an interface for the CableTV system 19 which implements the DOCSIS protocol. The DOCSIS protocol is implemented in 17.

Since the system may support life-line telephony, power may be available from the network. This power, if available, may be coupled into the system through the stand-by power converter 18 which provides voltage conversion, safety isolation, and current control. The network power source may, depending on configuration settings, provide power to other needed modules through switch 75.

If network powering is not available, switch 72 may be activated, if the modular system contains a stand-by power module and the user desires this module to be active during a power outage.

To process the data between the communications bus and the DOCSIS interface, the Microprocessor 13 may need RAM 15 and program instructions stored in 16, although other known configurations may be used.

The overall effect of the modular system of the invention is to connect a variety of devices together using optimal network technologies implemented in a modular approach to obtain a low cost and maintain future flexibility. To install a modular system of the invention, the user will preferably follow the following general steps:

(a) A system is created from modules that implement a collection of functions desirable to the user. The placement of these modules may preferably be in any order so that the user avoids complex instructions. If some module placement limitation exists, the sequence may be easily identifiable to the user.

(b) The user selects the proper connection of these devices based on the needs of the user and the constraints of the networks through a configuration process.

(c) The system preferably automatically performs the optimization of the internal structure that will allow the configuration desired by the user to be accomplished. An example of this may be telephony functions provided by the DOCSIS network going to an analog POTs service interface and having stand-by power.

(d) The internal connection and translation bridges between heterogeneous networks is constructed for performing the exchange of information desired by the user. An example of this may be the VoIP PACKETCABLE™ translated into an analog signal sent to an RJ-11 connector which then goes to existing POTs phones in the home.

(e) A means for performing network management to identify problems and suggest actions the user might do to correct the problem. In some embodiments, preferably at the user's option, the modular system may provide network management information to a remote system so that the remote system may implement required corrective action, initiate others to take corrective action, or analyze the problem and suggest the user take corrective action.

The ability to connect information between heterogeneous networks may be quite complex, possibly requiring not only the translation of the data between networks, but also the proper implementation of service characteristics. Such characteristics commonly include, sustained/maximum bandwidth, end-to-end delay, variations in delay, packet size, and methods to increase/decrease the information rate as the network gets congested.

For systems that implement fixed network interfaces, the problems are less complex because the network types are known and the permutations of network types are constrained. Network types are not limited by the modular system and this feature allows the Residential Gateway to implement technologies net yet created.

The device of the invention implements the goal of connecting disparate networks by dealing with certain basic network problems, preferably using the following method steps:

(a) Identifying the addressing of each networking type and keeping that address separate from the data transport. This address is useful only within the given module for that type of network.

(b) Providing directly the address mapping mechanism or seeking an external entity that performs that address translation mechanism.

(c) Supporting the proper network signaling protocol for the network within that module.

(d) An overall system controller looks at the source and destination Quality of Service parameters contained within each signaling protocol to establish the equivalent set of parameters that will accomplish the desired service.

(e) The logical internal path is created that supports the overall QoS and connects the two or more network interface modules. The source module and destination module(s) will be instructed to map the user packets into possibly another format since the packet formats of network interfaces may vary. Even for a given network interface the mapping format may vary depending on service type.

(f) The mechanism used to alter the data rates on one protocol (i.e. F4/F5 flows on ATM) are translated to a common pacing mechanism used internal to this system and passed between modules so that the pacing information can be forwarded to the other network, if a pacing mechanism exists in that protocol.

(g) If problems arise, the system has a user-configurable mechanism that is used to handle the problem. For example, a loss of line-power may cause the stand-by power system to become operational. Loss of a primary network interface may trigger the activation of a back-up network interface (i.e. modem dial-up).

The above description of the method and apparatus used to create a modular residential gateway has focused on its usage in the residential setting. The scope of this invention is not limited to that market and will find usefulness in the small business, medium business, and large business market. The types of modules that are useful in each market will vary as well as the mixture of modules that constitute a usable system. Furthermore, it is not necessary to alter the implementation of this modular approach to achieve all the desirable features that have been mentioned. The scope of this invention should thus be considered to be much broader than the residential setting.

Although exemplary embodiments of the invention have been described in detail above, those skilled in the art will readily appreciate that many additional modifications are possible in the exemplary embodiment without departing materially from the novel teachings and advantages of the invention. For example, System Information 12 may be combined with ROM 16. Microprocessor 13 may be combined with the interface logic as in this case, the DOCSIS interface 17.

What is claimed is:

1. A modular electronic communications system comprising:
at least two modules forming a first stack,
a modular design for providing electronic communications network connectivity having a variable geometric configuration having a shape determined by the number of modules, the electronic communications system being capable of accepting additional modules, and
said modules capable of transferring electronic messages between said modules.

2. The electronic communications system of claim 1, further comprising:
at least a second stack, wherein said second stack comprises at least one module, and
wherein said second stack may be positioned in a physically separate selected location from said first stack.

3. The electronic communications system of claim 1, wherein said modules may be placed in any order in said stacks.

4. The electronic communications system of claim 1, further comprising a means for allowing power to be distributed to said modules, said means for allowing power to be distributed to said modules comprising:
a processing element;
at least one power supply positioned in said stack;
means for conveying power requirements of each said module to said processing element, and
means for allowing said processing element to instruct each said module to obtain power from one of said at least one power supply.

5. The electronic communications system of claim 4, further comprising:
a stand-by power source that is always on, and
means for allowing said processing element to instruct electronic communication network modules to obtain power from said stand-by power source.

6. The electronic communications system of claim 1, further comprising:
a processing element,
at least one communication bus,
means for selecting at least one communications bus to send electronic messages, and
means for selecting at least one communications bus to receive electronic messages.

7. A method of using the electronic communications system of claim 6, the method steps comprising:
(a) using the said processing element to identify at least one communication bus to be used by the first of said at least two modules to communicate a message to at least one second module;
(b) using the said processing element to instruct the first module to select at least one of the at least one identified bus;
(c) using the said processing element to instruct each second module to select an identified bus;
(d) using the said first module to transmit a message on at least one of the at least one identified bus; and
(e) using each said second module to receive the message on said selected bus.

8. The electronic communications system of claim 1, further comprising means for allowing communications between heterogeneous protocols, wherein said means for allowing communications between heterogeneous protocols comprises:
means for selectively admitting a message entering the first of said at least two modules module from a first network using a first communication protocol,
means for allowing translation of said message by said first module to a second communications protocol,
means for selectively admitting said message into the second of said at least tow modules module, and
means for allowing translation by said second module of said second protocol to a third protocol used by a second network.

9. The electronic communications system of claim 1, further including a mechanism for allowing proper configuration of the electronic communication system comprising:
a processing element,
means for storing information in each said module about said module,
means for said processing element to retrieve said information from each said module, and
means for said processing element to configure the electronic communication system using said information.

10. A method for configuring the electronic communications system of claim 9, the method steps comprising:
(a) identifying modules present;
(b) determining the modules needing to communicate with each other;
(c) determining the types of addresses needed for each module;
(d) establishing internal communications paths between said modules; and
(e) establishing connections between modules when communications between said modules is required.

11. A method for configuring the electronic communications system of claim 9, the method steps comprising:
(a) identifying modules present;
(b) determining the modules needing to communicate with each other;
(c) determining the types of addresses needed for each module;
(d) establishing internal communications paths between said modules;
(e) constructing a customized information request;
(f) transmitting said customized information request to an external entity;
(g) receiving an answer to said customized information request; and
(h) implementing a system configuration.

12. The electronic communications system of claim 1, further comprising, a means for monitoring the operation of said modules, comprising:
a processing element,
means for allowing said processing element to communicate with said modules to retrieve information associated with the functioning of said modules, and
means for allowing said processing element to determine whether said modules are functioning within accepted parameters.

13. The electronic communications system of claim 12, further comprising means for allowing said processing element to communicate with other communications devices located externally.

14. A method for using the electronic communications system of claim 9, the method steps comprising:
(a) determining normal operational parameters of said modules;
(b) monitoring actual operational parameters of said modules;
(c) comparing said actual operation parameters with said normal operational parameters; and
(d) logging of events when said actual operational parameters are outside of said normal operational parameters.

15. The method of claim 14, further comprising the steps:
(e) allowing said processing element to communicate with at least one externally located device; and
(f) informing said externally located devices of events logged in method step (d).

16. The electronic communications system of claim 1, wherein said electronic communications system is located within a residence.

17. A method of using the electronic communications system of claim 16, comprising the step of receiving electronic messages from a cable television system.

18. A method of using the electronic communications system of claim 16, comprising the step of receiving an electronic message from an external source using a digital Subscriber Loop technology.

19. A method of using the electronic communications system of claim 16, comprising the step of receiving electronic messages form an external source using a form of metropolitan area networking technology.

20. A method of using the electronic communications system of claim 16, comprising the step of receiving electronic messages form an external source using a form of wide area networking technology.

21. The electronic communications system of claim 1, wherein said system is located within a business.

22. A method of using the electronic communications system of claim 21, comprising the step of receiving electronic messages from a cable television system.

23. A method of using the electronic communications system of claim 21, comprising the step of receiving electronic messages form an external source using digital subscriber loop technology.

24. A method of using the electronic communications system of claim 21, comprising the step of receiving electronic messages form an external source using a form of metropolitan area networking technology.

25. A method of using the electronic communications system of claim 21, comprising the step of receiving electronic messages form an external source using a form of wide area networking technology.
